(19) United States
(12) Patent Application Publication
(10) Pub. No.: US 2015/0358431 A1
(43) Pub. Date: Dec. 10, 2015

(54) ENHANCED DATA COMMUNICATIONS IN AN OPTICAL TRANSPORT NETWORK

(71) Applicant: Cisco Technology, Inc., San Jose, CA (US)

(72) Inventors: Gilberto Loprieno, Milano (IT); Luca Della Chiesa, Concorezzo (MI) (IT); Giacomo Losio, Tortona (AL) (IT)

(21) Appl. No.: 14/300,480

(22) Filed: Jun. 10, 2014

(51) Int. Cl. H04L 29/06; H04Q 11/00

(52) U.S. Cl. CPC H04L 69/04; H04Q 11/0066

(57) ABSTRACT

Techniques are described herein for enabling mapping of virtual lanes for data streams for transmission over an optical transport network (OTN). Line encoded data blocks of a first data stream are distributed at an endpoint device in an OTN. The line encoded data blocks of the first data stream are distributed across a plurality of second data streams such that the second data streams can be processed at a lower data rate than a data rate associated with the first data stream. A transcoding operation is performed on the data packets of each of the second data streams to generate transcoded data packets. The transcoded data packets are processed such that the transcoded data packets of each of the second data streams can be sent over the OTN at the lower data rate.

### TECHNICAL FIELD

The present disclosure relates to enabling mapping of virtual lanes for data streams for transmission over an optical transport network.

### BACKGROUND

Higher-speed Ethernet typically has to use existing copper (electrical) and fiber (optical) cables, e.g., in a data center and over the Internet. At this point in time, no technology exists to transport data at rates of 40 or 100 gigabits per second (G) as a single (serial) stream over both copper and fiber media between endpoints, but such transport becomes possible when the traffic is subdivided and transmitted via a plurality of lower data rate channels or virtual lanes. To assist the conversion between optical and electrical transmission, the Institute of Electrical and Electronics Engineers (IEEE) has established the 802.3ba standard for 40 G and 100 G for transmission over networks, e.g., the Internet. The 802.3ba standard implements the use of “virtual lanes” that subdivide the higher data rate optical signals for processing by lower data rate electronics at the physical coding sublayer (PCS). For example, a 40 G optical data rate may be subdivided into 5 G PCS units or lanes for electrical processing. In essence the 40 G data is multiplexed across 5 G lanes, e.g., eight lanes (40 G divided by 5 G).

### BRIEF DESCRIPTION OF THE DRAWINGS

FIG. 1 is a block diagram of an example optical network that provides PCS virtual lane mapping between nodes in an Optical Transport Network (OTN) according to the techniques presented herein.

FIG. 2 shows an example diagram for assigning a pool of virtual lanes to a set of Media Access Control (MAC) modules.

FIG. 3A shows an example diagram of a mapping process for enabling data of virtual lanes to be mapped over an OTN.

FIG. 3B shows transcoding and mapping of packets of a virtual lane into a container that can be transmitted over an OTN.

FIG. 4 shows an example flow chart depicting processes for performing the mapping operations.

FIG. 5 shows an example block diagram of a node configured to perform the mapping operations.

### DESCRIPTION OF EXAMPLE EMBODIMENTS

### Overview

Techniques are described herein for enabling mapping of virtual lanes for data streams for transmission over an Optical Transport Network (OTN). Line encoded data blocks of a first data stream are distributed at an endpoint device in an OTN. The line encoded data blocks of the first data stream are distributed across a plurality of second data streams such that the second data streams can be processed at a lower data rate than a data rate associated with the first data stream. A transcoding operation is performed on the data packets of each of the second data streams to generate transcoded data packets. The transcoded data packets are processed such that the transcoded data packets of each of the second data streams can be sent over the OTN at the lower data rate.

### Example Embodiments

Optical transport networks (OTN) generally comprise a number of optical fibers that are deployed over large geographical areas. Optical transport, in general, is quickly moving towards implementations for transmission of 100 Gigabit per second (100 G) data that can be widely deployed in the next few years, and solutions for 400 G and 1 Terabits per second (T) transport have been announced. As such, it is expected that further optical network standards will be released that support these and other line rates and signal speeds.

As described above, networks have been developed to employ both optical and electrical media for data transmission, and the optical data rates have evolved to transmit data at higher rates over an optical physical (PHY) link than those economically achieved over an electrical PHY link. In many environments optical signals are converted to electrical signals, and vice versa. For example, certain optical wavelengths (X) may be “dropped” at an optical network node. The data in the dropped wavelength are converted from the optical form and may be retransmitted over an electrically based network. The optical wavelengths may also need to be reconditioned via electrical processing due to optical path signal loss and optical distortions, and thereafter retransmitted over optical media. Due to the cost of the electrical conversion components, lower data rate electronics are preferred in some environments. PCS virtual lanes are employed to allow processing of high bandwidth protocols at lower speed. Virtual lanes enable encoded data blocks of a first data stream to be distributed across a plurality of second data streams such that the second data streams are processed at lower data rates than data rates associated with the first data stream. Virtual lanes may be created by an optical node that is part of an OTN, and data may be distributed across the virtual lanes by the optical node. Thus, the virtual lanes implemented by the optical node enable high data rate optical signals to be divided into streams of lower data rate optical signals across the virtual lanes. For example 40 G data may be subdivided into eight 5 G virtual lanes. Ideally, the data of the virtual lanes would be configured to be mapped in the OTN such that the data from the virtual lanes can traverse the OTN to a destination optical node.

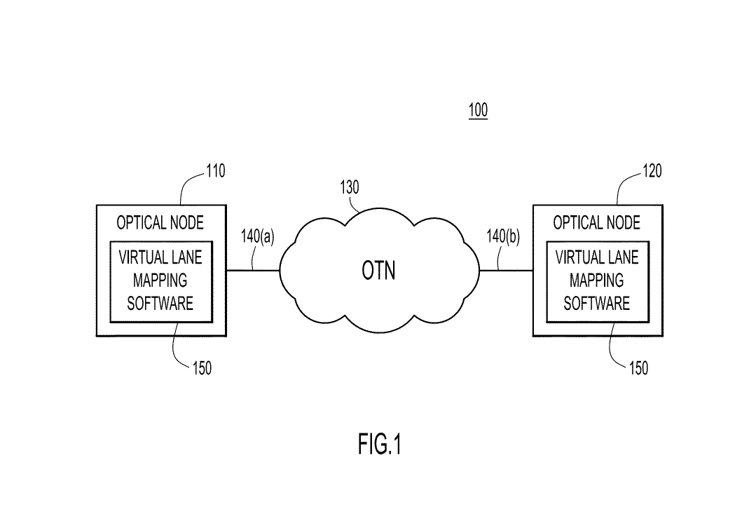

An example optical environment for enabling mapping of virtual lanes in an OTN is shown in FIG. 1. The environment, as indicated by reference numeral 100, has two optical nodes 110 and 120. Optical node 110 is configured to communicate with optical node 120 across an OTN. The OTN is shown at reference numeral 130. The OTN may refer to any optical transport network now known or heretofore contemplated. Nodes 110 and 120 are coupled to the OTN 130 by one or more optical fibers 140(a) and 140(b). Environment 100 is a simplified environment and it should be understood that many other optical nodes may exist in environment 100. In this regard, nodes 110 and 120 may be part of, e.g., a Metropolitan Area Network (MAN), Wide Area Network (WAN), or other optical network. Similarly, optical nodes are simplified and may contain many other components, such as optical-to-electrical (O/E) converters, electrical-to-optical (E/O) converters, splitters, combiners, routers, amplifiers, attenuators, transceivers, processors and storage components, among other components. Optical fibers 140(a) and 140(b) are typically single mode fibers and may comprise any number and type of optical fibers.

To ensure that data streams of the virtual lanes at each optical node are able to be transmitted in the OTN 130 at lower data rates associated with the virtual lanes, each of the nodes 110 and 120, i.e., endpoint nodes, has virtual lane mapping software 150 and supporting hardware. As described herein, the virtual lane mapping software 150 enables the optical nodes 110 and 120 to perform transcoding operations on data packets of virtual lanes and to process transcoded data packets such that the transcoded data packets can be sent over the OTN 130.

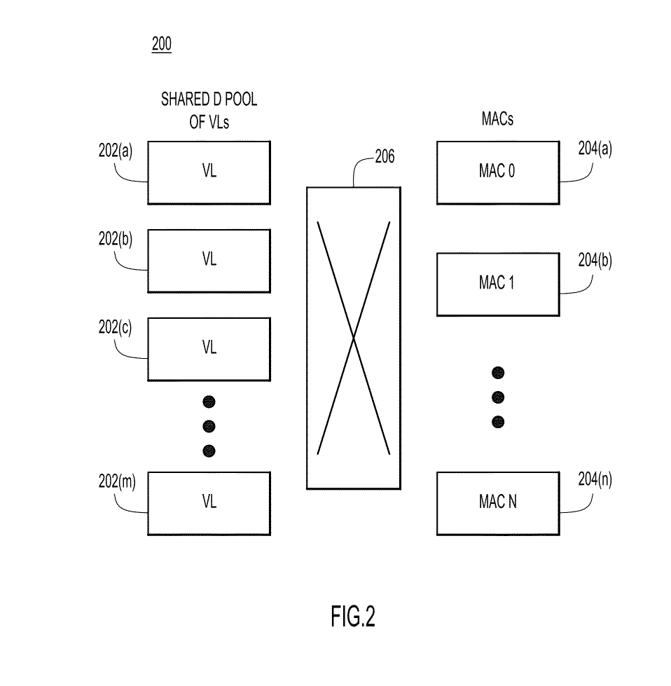

Reference is now made to FIG. 2. FIG. 2 shows an example diagram 200 that shows virtual lane assignment for one or more Media Access Control (MAC) modules. The virtual lanes are shown at reference numerals 202(a)-202(m) and the MAC modules are shown at reference numerals 204(a)-204(n). The virtual lanes, for example, are software representations of physical data streams for data that is to be sent by a particular optical node in an OTN 130. In one example, the optical node 110 may be configured to send 40 G data across the OTN 130 and may execute software to distribute the 40 G data across a plurality of 5 G virtual channels. As such, the virtual lanes enable adjustable rate communications over the OTN 130 between the optical nodes 110 and 120. For example, optical data communications may be exchanged over the OTN 130 with finer granularity (e.g., different data rates) than is presently allowed under fixed data speed standards of Ethernet interfaces. Thus, optical data that is less than (and up to) 40 G may be sent along a 40 G data channel between optical node 110 and optical node 120 using the virtual lanes implemented on optical node 110 and/or optical node 120.

The adjustable rate communications enable the optical nodes 110 and 120 to negotiate from each other the number of virtual lanes (and thus the bandwidth) to be used for data communications across the OTN 130. This negotiation is used to activate (or deactivate) one or more virtual lanes, and optical nodes can negotiate to activate extra virtual lanes to match a maximum bandwidth allowable by physical connections used by the communication interface. For example, if a maximum bandwidth of the physical connections increases, the optical nodes can negotiate to activate additional virtual lanes to fill up the extra available bandwidth in the OTN 130. Similarly, if a maximum bandwidth of the physical connections decreases, the nodes can negotiate to de-activate virtual lanes to match the smaller available bandwidth in the OTN 130.

Each of the MAC modules 204(a)-204(n) generates one or more processed data streams for transmission along one or more virtual lanes. FIG. 2 shows a mapping module 206, hosted, in software or hardware, by an optical node (node 110 and/or node 120). The mapping module 206 is configured to assign virtual lanes to one or more of the MAC modules. For example, virtual lanes 202(a) and 202(b) may be assigned to MAC module 204(a), and accordingly, virtual lanes 202(a) and 202(b) may carry data associated with MAC module 204(a). One or more other virtual lanes maybe assigned to other MAC modules in FIG. 2. The mapping module 206 keeps track (e.g., in a database) of the virtual lane-to-MAC module assignment. As data from the virtual lanes are transmitted in the OTN 130, the data may be arranged in a payload of a data stream of the OTN 130.

In current network environments, fixed hierarchical data rates vary significantly, and virtual lanes may be deployed at optical nodes to optimize packet transmission with finer increments allowed by existing fixed rate standards. On the other hand, OTN networks are increasingly becoming widely adopted, and often data from the virtual lanes cannot be mapped over the OTN at the lower data rates. For example, even though the virtual lanes at an optical node may enable 40 G data to be mapped into multiple 5 G virtual lanes, existing OTN technology does not allow the individual 5 G data of the virtual lanes to be sent at the 5 G data rate across the OTN 130. Existing standards have been developed to enable traffic to be mapped over an OTN, but these existing standards lose the data rate granularity provided by virtual lane technology. For example, the International Telecommunication Union (ITU) standard G.709 provides a general framework for mapping data traffic over OTNs, but as currently defined, the G.709 standard does not allow for preservation of the virtual lane-to-MAC module mapping performed by an optical node before data transmission. In other words, the G.709 standard lacks transparency for maintaining the virtual lane-to-MAC module mapping as data packets in specific virtual lanes (corresponding to specific MAC modules) are sent in the OTN 130. Without such transparency, it is difficult, if not impossible, for endpoint optical nodes to reassemble or reorder packet streams in a virtual lane in an appropriate order as they correspond to the specific MAC modules.

The techniques described herein alleviate these drawbacks by transcoding data packets on each of the virtual lanes and processing the transcoded data packets such that the data packets can be sent in the OTN with the virtual lane-to-MAC module assignment preserved. In one example, a procedure, such as the Generic Mapping Procedure (GMP), is applied to the data streams and packets in each of the virtual lanes before they are transmitted in the OTN 130 such that the virtual lane-to-MAC module assignment is maintained and such that the destination optical endpoints can properly reassemble and reorder the packets upon receipt. In other words, the techniques described herein overcome the limitations of current OTN mapping standards (e.g., the ITU G.709 standard) which result in termination of the virtual lane-to-MAC module assignment information. In particular, G.709 contemplates only mapping of packets, therefore additional information such as, e.g., fields added by previous layers, are removed. In the case of a virtual lanes implementation, for instance, markers are added to data packets to allow deskewing and traffic routing and are essential to protocol operation. If such makers were mapped according to the standard G.709 method, those markers would be lost. In any event, virtual lane approaches and other possible variable rate PCS implementations are not contemplated by G.709. The techniques described herein present an alternate method to transcode and send virtual lane data packets oven an OTN.

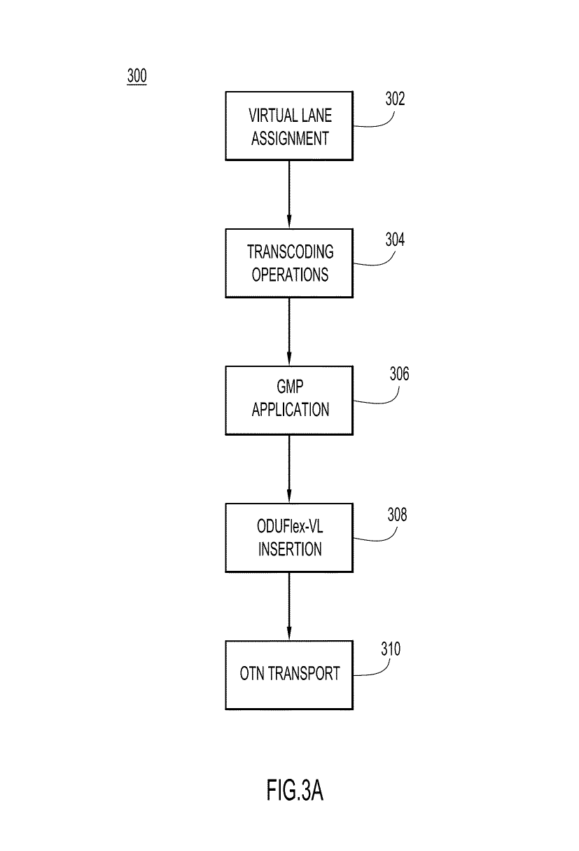

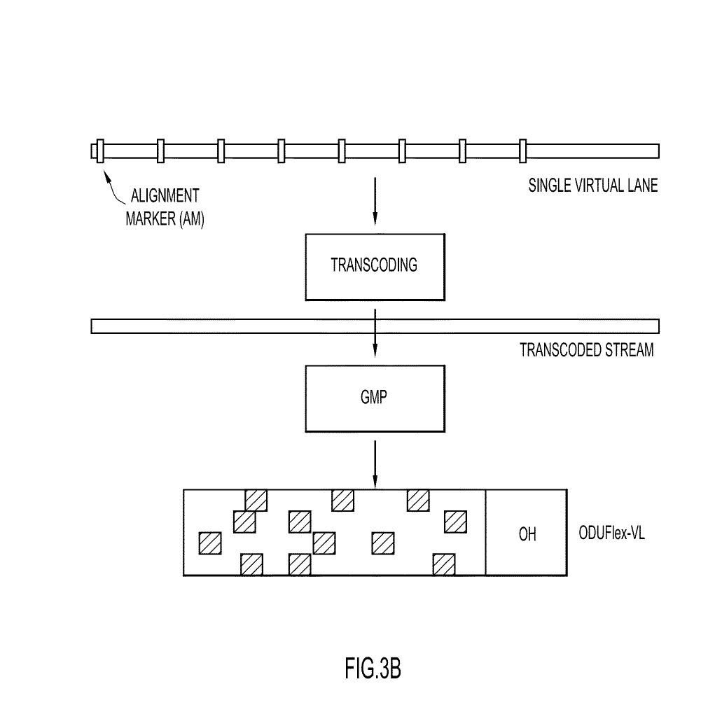

Reference is now made to FIG. 3, which shows an example diagram 300 that depicts a process for enabling data of virtual lanes to be mapped over an OTN. It is assumed that the process described in FIG. 3 may be performed by node 110 or node 120 (or any other node in the OTN 130). For simplicity, it is assumed that node 110 performs the operations described in FIG. 3. At reference numeral 302, the virtual lane assignment is performed for a series of MAC modules, as described in connection with FIG. 2 above. For example, the node 110 may distribute line encoded data blocks of a first data stream (e.g., 40 G data) to a plurality of virtual nodes such that a plurality of second data streams (a plurality of 5 G data that together comprises the 40 G data) can be processed at a lower data rate. At operation 304, data for each of the virtual lanes is transcoded to reduce the bandwidth of each virtual lane. For example, data may be transcoded from a first encoding scheme (e.g., 64-bit data to 66-bit line code (64 B/66 B)) to a second encoding scheme (e.g., 512-bit data to 513-bit line code (512 B/513 B)), thereby reducing the bandwidth for each virtual lane.

At operation 306, a GMP is applied to the transcoded data packets of each virtual lane. For example, the virtual lanes may each have a constant bit rate (CBR) stream, and GMP mapping of the data in the virtual lanes enables the data of the virtual lanes to be incorporated or placed into an OTN-compatible container. The OTN-compatible container is referred to as a flexible Optical Data Unit (ODUFlex) container for virtual lanes (ODUFlex-VL). It should be appreciated that any OTN container in compliance with the Institute of Electrical and Electronic Engineering (IEEE) 802.3 standard may be used and that ODUFlex-VL is merely an example. At 308, the data in the virtual lanes are placed into the ODUFlex-VL containers. As such, the virtual lane-to-MAC module assignment information is preserved for each data stream as it is transmitted in the OTN 130. Additionally, the transcoded data packets of each virtual lane can be transmitted in the OTN 130 since they are embedded or incorporated into the ODUFlex-VL container, which is a data container capable of being transmitted in the OTN 130. FIG. 3B depicts the transcoding and GMP application operations of 306 and 308. As shown, a virtual lane transcoded to reduce its bandwidth to, e.g., a value below the ODUFlex-VL payload. GMP is then applied to the transcoded stream such that packets are mapped inside the ODUFlex payload area. GMP distributes stuffing (hash mark areas). ODUFlex-VL overhead (OH) is consistent with standard ODU overhead defined by G.709.

The ODUFlex-VL containers that pertain to the same MAC module (e.g., if there is more than one virtual lane that is mapped to a MAC module) can be aggregated using an enhanced scheme wherein some bytes of a data stream (e.g., bytes JC1/JC2/JC3, etc.) are used for GMP mapping and other bytes of the data stream (e.g., bytes JC4/JC5/JC6) are used to manage the concatenation of different virtual lanes. JC1-JC3 provide information to the receiver to identify the location of the stuffing bytes and correctly demap payload data, while JC4-JC6 are filled with a concatenation pointer described in G.709 chapter 18.1.2.2.2.

Additionally, this scheme may be used to aggregate data streams originating from different MAC modules that are assigned different virtual lanes. The scheme can also be used to add or drop a virtual lane from a single data flow.

In any case, after data is embedded or incorporated into the ODUFlex-VL container, the data for each virtual lane is sent in the OTN, as shown at 310 in FIG. 3. As stated above, the transcoded packets of each of the virtual lanes are able to be sent over the OTN at the lower data rates allowed by each of the virtual lanes. Since the OTN container maintains the virtual lane-to-MAC module mapping information, the destination node is able to correctly arrange and order the data packets for each virtual lane. In one example, the data packets for each virtual lane may contain one or more markers (every virtual lane has a single marker of 66 bits (one word) repeated every 16383 66-bit words) that, upon receipt by a destination node, are readable by the destination node to correctly order and arrange the data stream, regardless of the order in which the data packets are received by the destination node in the OTN.

It should be appreciated that the OTN mapping operations may be separated between processing elements, and thus, the process described in FIG. 3 need not occur on the same device. In one example, a first device may perform the virtual lane assignment process and a second device may perform the GMP mapping procedure. For example, a network processor (e.g., the mapping module 206) may perform the virtual lane mapping operations on a line card, while the OTN mapping function could be implemented on a pluggable optical module. In this example, it may not be necessary to add the OTN complexity to the device performing the virtual lane mapping operation.

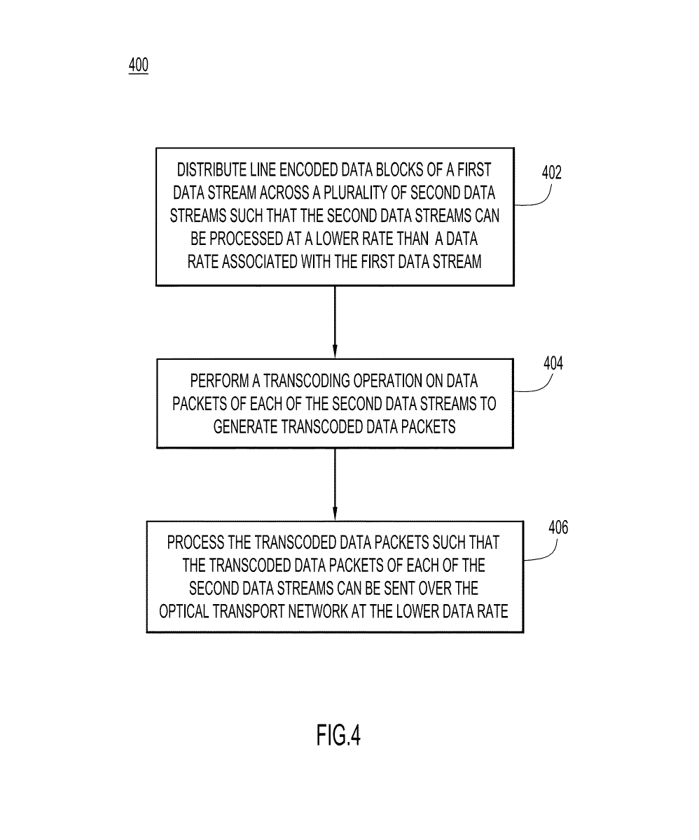

Reference is now made to FIG. 4. FIG. 4 shows an example flow chart 400 depicting processes for performing the mapping operations. At operation 402, an optical node (e.g., node 110 or 120) distributes line encoded data blocks of a first data stream across a plurality of second data stream. The line encoded data blocks are distributed such that the second data streams can be processed at a lower data rate than a data rate associated with the first data stream. At 404, a transcoding operation is performed on the data packets of each of the second data streams to generate transcoded data packets. At 406, the transcoded data packets are processed such that the transcoded data packets of each of the second data streams can be sent over the optical transport network at the lower data rate. The transcoded data packets, for example may be sent over the optical transport network using a container capable of being transmitted over an optical transport network and that is configured to maintain the virtual lane-to-MAC module mapping information of the data stream for each virtual lane.

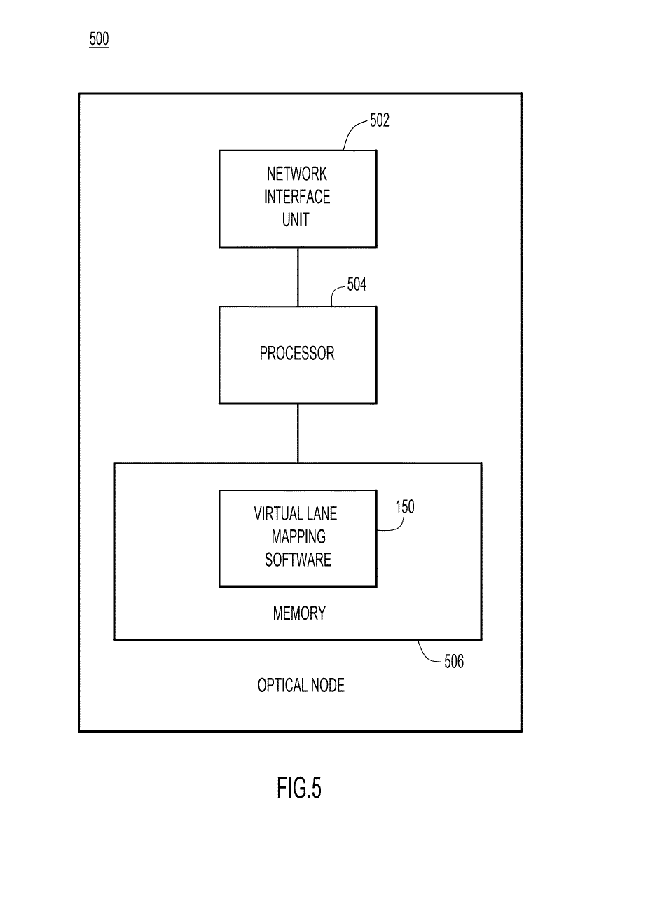

Reference is now made to FIG. 5, which shows an example block diagram of a node configured to perform the virtual lane mapping operations as described herein. The node is referred to generally in FIG. 5 as node 500, but it should be appreciated that the node 500 may be either node 110 or node 120 described in connection with FIG. 1, above. The node 500 may comprise a network interface unit 502, a processor 504 and a memory 506.

The network interface unit 502 is an interface that is configured to send and receive network traffic that is at a higher data rate that is subdivided into lower data rate traffic for PCS lane processing. The network interface unit 502 is coupled to the processor 504. The processor 504 may be a programmable processor, e.g., microprocessor, digital signal processor (DSP), or microcontroller or a fixed-logic processor such as an application specific integrated circuit (ASIC) or Field Programmable Gate Array (FPGA). As such, the processor 504 may represent plural processors within the optical node that perform general, programmable, and specific fixed logic operations, e.g., to perform PCS encoding and encryption. The processor 504 may comprise a processor with a combination of fixed logic and programmable logic, e.g., a System on a Chip (SoC), ASIC or FPGA with fixed logic, and a microprocessor and memory section.

The memory 506 may be of any type of tangible processor readable memory (e.g., random access, read-only, etc.) that is encoded with or stores instructions, such as virtual lane mapping software 150, e.g., for execution by processor 504. Thus, software or process 150 may be executed by software, firmware, fixed logic, or any combination thereof that cause the processor 504 to perform the functions described herein. Briefly, software 150 provides enables mapping of virtual lanes for data streams for transmission over an OTN. In general, software may be embodied in a processor readable medium that is encoded with instructions for execution by a processor that, when executed by the processor, are operable to cause the processor to perform the functions described herein.

It should be appreciated that the techniques described above in connection with all embodiments may be performed by one or more computer readable storage media that is encoded with software comprising computer executable instructions to perform the methods and steps described herein. For example, the operations performed by the nodes 110 and 120 may be performed by one or more computer or machine readable storage media (non-transitory) or device executed by a processor and comprising software, hardware or a combination of software and hardware to perform the techniques described herein.

In summary, a method is provided comprising: at an endpoint device in an optical transport network, distributing line encoded data blocks of a first data stream across a plurality of second data streams such that the second data streams can be processed at a lower data rate than a data rate associated with the first data stream; performing a transcoding operation on data packets of each of the second data streams to generate transcoded data packets; and processing the transcoded data packets such that the transcoded data packets of each of the second data streams can be sent over the optical transport network at the lower data rate.

In addition, a computer readable storage media is provided that is encoded with software comprising computer executable instructions and when the software is executed operable to: distribute at an endpoint device in an optical transport network line encoded data blocks of a first data stream across a plurality of second data streams such that the second data streams can be processed at a lower data rate than a data rate associated with the first data stream; perform a transcoding operation on data packets of each of the second data streams to generate transcoded data packets; and process the transcoded data packets such that the transcoded data packets of each of the second data streams can be sent over the optical transport network at the lower data rate.

Furthermore, an apparatus is provided comprising: a network interface unit; and a processor coupled to the network interface unit, and configured to: distribute at an endpoint device in an optical transport network line encoded data blocks of a first data stream across a plurality of second data streams such that the second data streams can be processed at a lower data rate than a data rate associated with the first data stream; perform a transcoding operation on data packets of each of the second data streams to generate transcoded data packets; and process the transcoded data packets such that the transcoded data packets of each of the second data streams can be sent over the optical transport network at the lower data rate.

The above description is intended by way of example only. Various modifications and structural changes may be made therein without departing from the scope of the concepts described herein and within the scope and range of equivalents of the claims.

What is claimed is:

1. A method comprising:
at an endpoint device in an optical transport network, distributing line encoded data blocks of a first data stream across a plurality of second data streams such that the second data streams can be processed at a lower data rate than a data rate associated with the first data stream;
performing a transcoding operation on data packets of each of the second data streams to generate transcoded data packets; and
processing the transcoded data packets such that the transcoded data packets of each of the second data streams can be sent over the optical transport network at the lower data rate.

2. The method of claim 1, further comprising
aggregating the transcoded data packets; and
mapping the aggregated transcoded data packets to an optical transport network container packet.

3. The method of claim 1, wherein processing comprises processing the transcoded data packets to corresponding optical transport network container packets in compliance with an Institute of Electrical and Electronics Engineering (IEEE) 802.3 standard.

4. The method of claim 1, wherein processing comprises processing the transcoded data packets using a Generic Mapping Procedure.

5. The method of claim 1, wherein processing comprises processing the transcoded data packets such that information of the transcoded data packets is embedded in a packet readable by the optical transport network.

6. The method of claim 1, wherein processing comprises processing the transcoded data packets to corresponding optical transport network container packets that are Optical Data Unit (ODU) packets.

7. The method of claim 6, wherein processing comprises processing the transcoded data packets to the corresponding optical transport network container packets that maintain markers for each of the second data streams for transport across the optical transport network.

8. A computer readable storage media encoded with software comprising computer executable instructions and when the software is executed operable to:
distribute at an endpoint device in an optical transport network line encoded data blocks of a first data stream across a plurality of second data streams such that the second data streams can be processed at a lower data rate than a data rate associated with the first data stream;
perform a transcoding operation on data packets of each of the second data streams to generate transcoded data packets; and
process the transcoded data packets such that the transcoded data packets of each of the second data streams can be sent over the optical transport network at the lower data rate.

9. The computer readable storage media of claim 8, further comprising instructions that are operable to:
aggregate the transcoded data packets; and
map the aggregated transcoded data packets to an optical transport network container packet.

10. The computer readable storage media of claim 8, wherein the instructions that are operable to process comprise instructions that are operable to process the transcoded data packets to corresponding optical transport network container packets in compliance with an Institute of Electrical and Electronics Engineering (IEEE) 802.3 standard.

11. The computer readable storage media of claim 8, wherein the instructions that are operable to process comprise instructions that are operable to process the transcoded data packets using a Generic Mapping Procedure.

12. The computer readable storage media of claim 8, wherein the instructions that are operable to process comprise instructions that are operable to process the transcoded data packets such that information of the transcoded data packets is embedded in a packet readable by the optical transport network.

13. The computer readable storage media of claim 8, wherein the instructions that are operable to process comprise instructions that are operable to process the transcoded data packets to corresponding optical transport network container packets that are Optical Data Unit (ODU) packets.

14. The computer readable storage media of claim 13, wherein the instructions that are operable to process comprise instructions that are operable to process the transcoded data packets to the corresponding optical transport network container packets that maintain markers for each of the second data streams for transport across the optical transport network.

15. An apparatus comprising:
a network interface unit; and
a processor coupled to the network interface unit, and configured to:
distribute at an endpoint device in an optical transport network line encoded data blocks of a first data stream across a plurality of second data streams such that the second data streams can be processed at a lower data rate than a data rate associated with the first data stream;
perform a transcoding operation on data packets of each of the second data streams to generate transcoded data packets; and
process the transcoded data packets such that the transcoded data packets of each of the second data streams can be sent over the optical transport network at the lower data rate.

16. The apparatus of claim 15, wherein the processor is further configured to:
aggregate the transcoded data packets; and
map the aggregated transcoded data packets to an optical transport network container packet.

17. The apparatus of claim 15, wherein the processor is further configured to process the transcoded data packets to corresponding optical transport network container packets in compliance with an Institute of Electrical and Electronics Engineering (IEEE) 802.3 standard.

18. The apparatus of claim 15, wherein the processor is further configured to process the transcoded data packets using a Generic Mapping Procedure.

19. The apparatus of claim 15, wherein the processor is further configured to process the transcoded data packets such that information of the transcoded data packets is embedded in a packet readable by the optical transport network.

20. The apparatus of claim 15, wherein the processor is further configured to process the transcoded data packets to corresponding optical transport network container packets that are Optical Data Unit (ODU) packets.
